(19) United States
(12) Patent Application Publication
(10) Pub. No.: US 2007/0103291 A1
(43) Pub. Date: May 10, 2007

(54) Inductively powered devices

(75) Inventor: Guy Adams, Stroud (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY

(21) Appl. No.: 11/585,177

(22) Filed: Oct. 24, 2006

(30) Foreign Application Priority Data
Oct. 27, 2005 (GB) 0521835.9

(51) Int. Cl. G08B 1/08; G08B 13/14; G05B 19/00; G06F 17/00

(52) U.S. Cl. 340/539.1; 235/375; 340/5.83; 340/572.8

(57) ABSTRACT

An inductively powered device comprises a memory tag (13) and an additional functional device (10) for powering by and communication with a reader device (11) emitting radio frequency signals. The inductively powered device is adapted such that when the memory tag (13) is powered by a reader device (11), the additional functional device (10) is also powered by the reader device (11) and carries out its function.

This application claims priority from Great Britain patent application 0521835.9, filed Oct. 27, 2005. The entire content of the aforementioned application is incorporated herein by reference.

### FIELD OF THE INVENTION

The invention relates to inductively powered devices. In particular embodiments, it relates to inductively powered displays, to inductively powered displays associated or used with inductively powered memory tags, or to inductively powered devices associated with inductively powered memory tags.

### BACKGROUND TO THE INVENTION

Transponder devices respond to an input signal by giving an output signal in response. The input signal, in many classes of transponder, serves to power the transponder. A widely used form of transponder device is the RFID tag—radio frequency power from a reader device is received by an antenna of the RFID tag. The RFID tag is powered and emits data in the form of an identifier by modulation of the power received. The present applicants have proposed forms of transponder device, powered in a similar manner to RFID tags but designed to be read at short range and with memories for storing significant digital content. Data storing transponder devices of this general type are here termed memory tags—RFID tags may be considered a more limited form of memory tag than that discussed in more detail below proposed by the present applicants.

Data provided in memory tags is typically displayed in displays forming a part of reader devices used to power and read data from or write data to memory tags. While this is satisfactory for many use contexts, it is not appropriate to all use contexts—particularly when it is desired for a party other than a user controlling a reader device to have access to or control over data stored in a memory tag.

### SUMMARY OF THE INVENTION

In a first aspect, the invention provides an inductively powered device comprising a memory tag and an additional functional device for powering by and communication with a reader device emitting radio frequency signals, adapted such that when the memory tag is powered by a reader device, the additional functional device is also powered by the reader device and carries out its function.

### DESCRIPTION OF DRAWINGS

Specific embodiments of the invention will now be described, by way of example, with reference to the accompanying drawings, of which:

FIG. 1 shows elements of a display suitable for use in embodiments of the present invention;

FIG. 2 shows a display device and a powering device according to an embodiment of the present invention;

FIG. 3 shows a memory tag and a reader device suitable for use in embodiments of the present invention;

FIG. 4 shows a physical appearance of the memory tag of FIG. 3;

FIG. 5 shows a display device, a memory tag, and a reader device according to an embodiment of the present invention;

FIG. 6 illustrates a method for communication between a reader device on the one hand and a memory tag and a display device on the other hand according to an embodiment of the invention;

FIG. 7 shows a biometric sensor, a memory tag, and a reader device according to an embodiment of the present invention; and

FIG. 8 illustrates a method for reading protected data from a memory tag by obtaining biometric readings from a biometric sensor according to an embodiment of the invention.

### DESCRIPTION OF SPECIFIC EMBODIMENTS

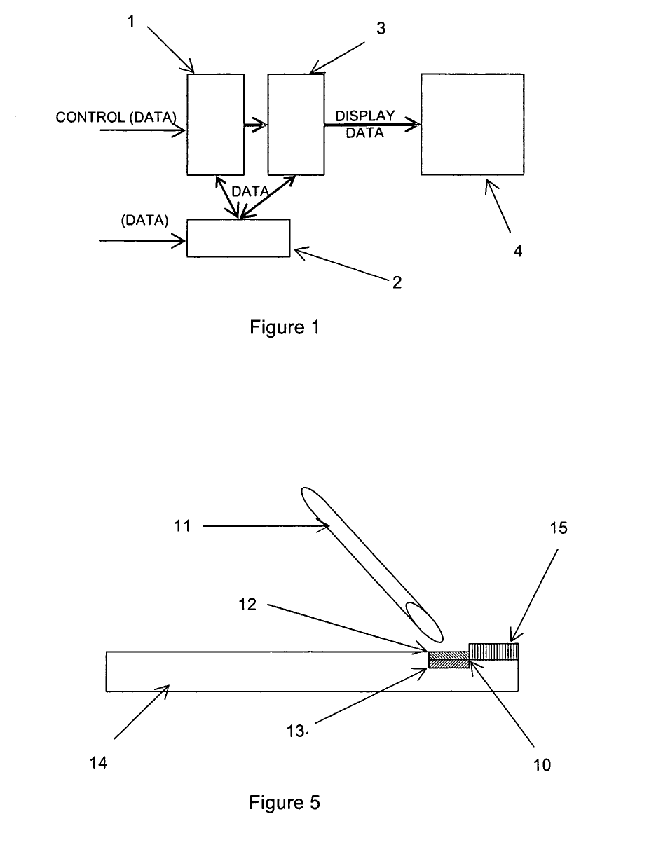

Elements of exemplary conventional display functionality will first be described with reference to FIG. 1 so that elements of embodiments of the invention described further below may be placed in an appropriate context.

In such exemplary conventional display functionality, input logic 1 receives control signals and responds to these control signals to operate a display driver 2. The display driver provides display data signals appropriate to drive the display element or elements 4. Data defining an image for display is either received at the input logic 1 and in most arrangements stored in a memory 2, or in other arrangements is provided directly to the memory 2. The memory 2 is shown here as one element—in practice, multiple memories may be employed in a display system (a main memory storing a whole image or a series of images, and a buffer memory for storing display data signals for providing to the display elements themselves). Data for display and control signals (which may be provided together and interpreted by the input logic 1) are provided to the display functionality. Control and data for display are provided to the display driver 3 (generally a conventional circuit designed for specific display elements) in a form in which it can then provide display data signals to the display element or elements 4 to display the image described by the data.

For an extremely simple display, as is appropriate to some embodiments, it will be possible to dispense with some of these functional elements. For a one-pixel, on/off, display, no memory 2 would be needed, and the input logic 1 may amount simply to detection of when the display element 4 should be activated (in such a case, input logic 2, display driver 3 and even display element 4 could be combined together in simple circuitry). For a two-dimensional multipixel display with multivalued pixels, the elements shown in FIG. 1 are appropriate.

Input logic 1 may be comprised in a processor that has other functions in the device of which the display functionality forms a part. Alternatively, input logic 1 may itself be downstream of a main processor.

In the description of the embodiments of the invention that follow, display functionality will be shown as a functional block—reference back to FIG. 1 is appropriate for further consideration of the elements of that functional block. Exemplary display technologies, or technology constraints, will be described for the embodiments that follow. The person skilled in the art will thus appreciate how conventional display technologies can be employed to produce embodiments of the invention as described below.

FIG. 2 shows an inductively powered display device 20 according to an embodiment of the invention, together with a powering device 21 which provides both power and data for display to the display device 20. Provision of power and data is comparable to that used in RFID technology—described in many reference sources, for example “RFID Handbook”, Klaus Finkenzeller, 1999, John Wiley & Sons. The arrangement shown here is designed to for the display device to be powered at relatively close range (near-contact) by the powering device and for data to be rapidly transmitted between them—data can thus be provided for display by “brushing” the powering device across the display device.

The display device 20 comprises a resonant circuit part 32 and a rectifying circuit part 33, together with display functionality 24. The resonant circuit part 32 comprises an inductor L2 shown at 35 and a capacitor C2 shown at 36 connected in parallel. The rectifying circuit part 33 comprises a diode D1 shown at 40 connected to the resonant circuit part 32 in a forward biased direction and a capacitor C4 shown at 41 connected in parallel with the components of the resonant circuit part 32. The rectifying circuit part 33 operates as a half-wave rectifier to provide power to display functionality 24.

The powering device 21 comprises a resonant circuit part 51 which comprises an inductor L1 shown at 52, in this example an antenna and a capacitor C1 shown at 53 connected in parallel. A signal generator 54 is connected to the resonant circuit part 51 to provide a drive signal. An amplitude modulator is shown at 61 operable to control the amplitude of the drive signal supplied from the frequency generator 54 to the resonant circuit part 51. A control unit 62 is operable to control the amplitude modulator 61 to provide data signals comprising control data and image data for display to the display device 20 and hence to the display functionality 24.

For the arrangement described above, it is particularly suitable to use display technologies which have a low power demand (such as low power CMOS) and which have very little latency on being powered on. For other contexts (for example, where near-contact is not required and the powering period may thus be longer), a broader range of technologies may be suitable. If the powering device is left in extended communication with the display device, series of images (or even video) could be displayed using this approach. Embodiments of the invention may use either traditional monostable displays which need to be refreshed, or bistable or monostable displays which do not require this. Both types of display, and their application for embodiments of the invention, are described briefly below.

A suitable traditional monostable display technology would be low power CMOS liquid crystal display (LCD). To maintain a positive image value, each LCD pixel element needs to receive a refresh signal at a regular interval. If the display technology unit is unpowered, there will be no image shown on the LCD display. In embodiments of the invention utilising conventional LCD display technologies, an image is shown on the LCD display only when power is provided—for a “brush and go” design such as that described in FIG. 2, this would mean that the image was only briefly visible. This may be advantageous in certain contexts—for example as a visual indication to be provided, privately, to the user of the powering device alone. This use is more apparent when the display is used together with a memory tag (as is described in further embodiments below). It should be noted that for this use, the image data need not be provided by the powering device, but may instead be stored in a memory of the display functionality unit. In such cases, it may not even be necessary for any signal to be provided by control unit 62—simple powering of the display device 20 is sufficient to result in the stored image being displayed. Alternatively, the stored image may only be displayed if particular control data is received from the powering device 21—in such an arrangement, the stored image may be displayed only to authorised viewers provided with a control code to be provided to input logic of the display functionality. Where a stored image of this kind is held by the display device 20, it is necessary for at least a part of the memory used by the display device 20 to be non-volatile so that the image data may be stored even when the display device is unpowered. Where there is no stored image, embodiments may or may not employ non-volatile memory (it may be desirable to use non-volatile memory to store aspects of the input logic) but may retain image data in volatile memory.

Alternative bistable or multistable display technologies do not require refreshing in this manner. A pixel element has more than one stable state, the different display states having different image values, so an image may persist even if the elements are unpowered simply by ensuring that different pixel elements are in different ones of their stable states. Suitable commercially available technologies are the BiNem technology of Nemoptic of Magny les Hameaux, France, and the E Ink technology of E Ink Corporation, Cambridge, Mass., USA. Again, it is desirable in the context described for FIG. 2 for the technology to have low power requirements and to have little latency on power up, but as before, these requirements are dependent on context. In this arrangement, the displayed image persists even when the display device is unpowered. In such an arrangement, even a relatively simple display may have a range of different uses. For example, a powering device may provide image data personalised to a user so that the display device reveals the user's name after being powered by the powering device—this may be used to indicate that the user was the last person to read a document on which the display device was mounted, for example. Alternatively, a display device could be mounted in a library book, and on checking out of the book, a librarian's powering device could write the return date into the display device.

In further embodiments of the invention, display devices such as that described above with reference to FIG. 2 are provided in conjunction with memory tags. Memory tags suitable for use with embodiments of the invention will now be described with reference to FIG. 3, which also shows a reader device analogous to the powering device of FIG. 2 for reading data from the memory tag.

Most generally, a memory tag is a passive electronic circuit powered by a reader device and containing a non-volatile memory in which data is stored. Generally, memory tags are inductively powered by RF transmissions—the best known examples are RFID tags as described above. A further type of memory tag, suitable for near-contact reading with high data rate transmission, is described below. Elements of memory tag 30 which are directly analogous to those of display device 20 are not described further below—similarly, elements of reader device 31 which are directly analogous to those of powering device 21 are not described further below.

As for the display device 20, the tag 30 comprises a resonant circuit part 32 and a rectifying circuit part 33, now together with a non-volatile memory 34. The resonant circuit part 32 further comprises a controllable capacitive element generally indicated at 37, in the example of FIG. 1 comprising a capacitor C3 shown at 38 and a switch S1 shown at 39. The memory 34 comprises a data store generally illustrated at 45 comprising a plurality of data units 46. A program 49 controls the behaviour of the memory tag.

In addition to the elements described above, the reader 31 further comprises a demodulator, generally shown at 55. The demodulator 55 comprises a splitter 56 connected to the frequency generator to split off a part of the drive signal to provide a reference signal. A coupler 57 is provided to split off part of a reflected signal reflected back from the resonant circuit part 51, and pass the reflected signal to a multiplier shown at 58. The multiplier 58 multiplies the reflected signal received from the coupler 57 and the reference signal received from the splitter 56 and passes the output to a low pass filter 59. The low pass filter 59 passes a signal corresponding to the phase difference between the reference signal and the reflected signal to an output 60. An amplitude modulator is shown at 61 operable to control the amplitude of the drive signal supplied from the frequency generator 54 to the resonant circuit part 51. The control unit 62 is operable to receive the output 60 from the low pass filter 59 and validate the received data.

A signal comprising a data unit is transmitted to the reader 31 by operating switch S1 shown at 39. This varies the resonant frequency of the resonant circuit part 32. This change in resonant frequency causes the phase of the signal reflected from the resonant circuit part 51 to vary with respect to the signal provided by the signal generator 54. This relative phase shift can be processed by the multiplexer 58 and low pass filter 59 to produce a digital output 63 as described in our earlier co-pending application published as GB2395628A.

When the tag 30 is moved sufficiently close to a reader 31 so that inductive coupling can be established between the resonant circuit parts 51, 32, power will be supplied to the memory 34 to run the program 49 and render the tag operational. A central part of tag operation is to transmit the data units 46 held in the data store 45. These are read from the data store 45 and transmitted as a part of a packet by operation of switch S1 under operation of the program 49.

It is particularly desirable that the tag 30 be provided as an integrated circuit, for example as a CMOS integrated circuit. A schematic of such an integrated circuit is show at 80 in FIG. 2. The inductor L2 is shown at 35, here as an antenna coil having only a single turn although any number of turns may be provided as appropriate. The capacitor C4 is shown at 41, and the remaining components of the resonant circuit part and rectifying circuit part 33 are shown at block 81. The memory is shown at 34. The memory 34 provides 1 Mbit of capacity of non-volatile memory and is of an area of approximately 1 mm2, and uses FRAM (ferroelectric random access memory) or MRAM (magnetoresistive random access memory) or similar memory technology requiring low power. The memory tag 30 is of a substantially square shape in plan view with an external dimension D for the sides of around 1 mm.

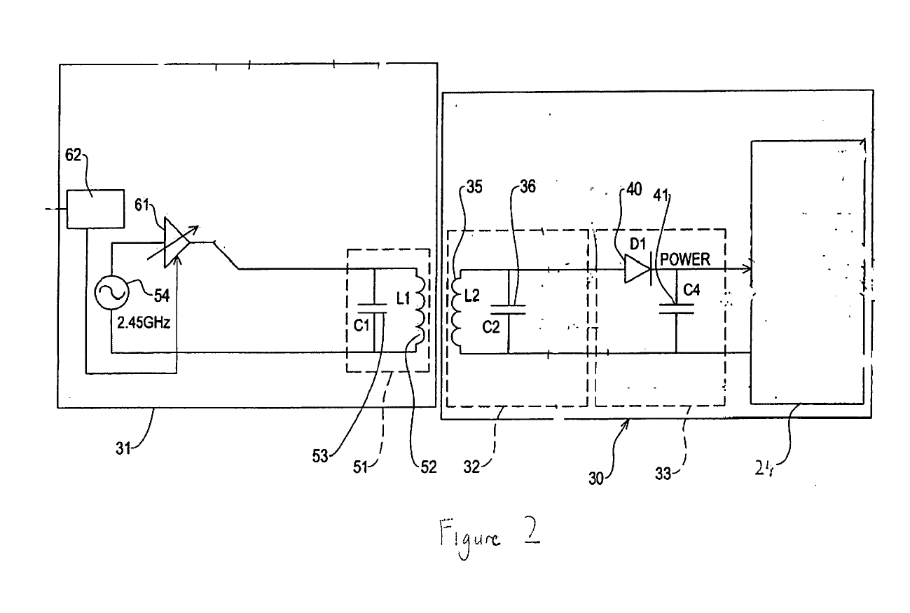

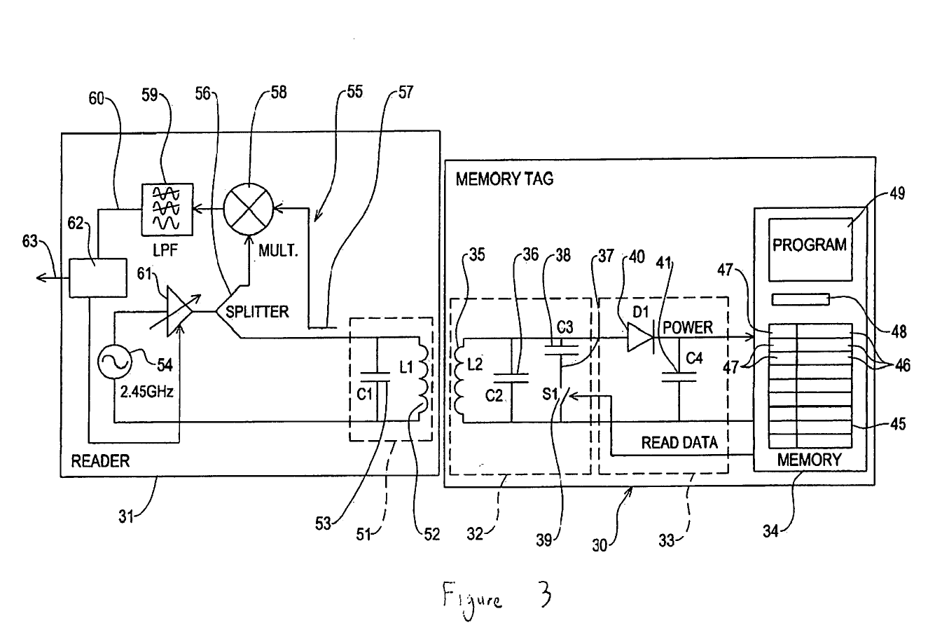

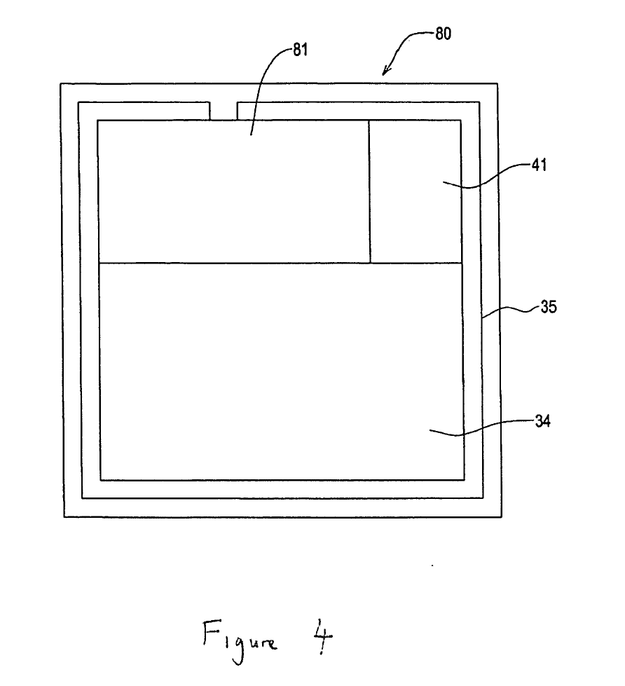

FIG. 5 shows an embodiment in which the display device of FIG. 2 and the memory tag of FIG. 3 are collocated to form a composite device. Reader device 11 has the elements of reader device 31 shown in FIG. 3—it has capacity both to receive data from a memory tag and to send data to a display device (and also to the memory tag, in some embodiments). The memory tag 13 and the circuitry 12 of the display device 10 (other than the display elements 15) are stacked over each other such that reader device 31 will power both the memory tag 13 and the display device 10 at the same time (the skilled person will appreciate in individual design contexts how this functional task may be achieved most effectively). This display device circuitry 12 is essentially similar, physically, to the physical elements of the memory tag 13 as shown in FIG. 4. The display device 10 and the memory tag 13 differ essentially only in the display elements 15—these are disposed to the side of the circuitry 12 and memory tag 15 so that these can be seen even when the reader 11 is powering the display device 10 and the memory tag 13. The substrate 14 on which all these components are mounted may be effectively any substrate in which a use for the composite device may be found: a document; product packaging; a wall of an electrical appliance; virtually any other non-perishable physical product. Use models of such a composite device as this are discussed briefly below.

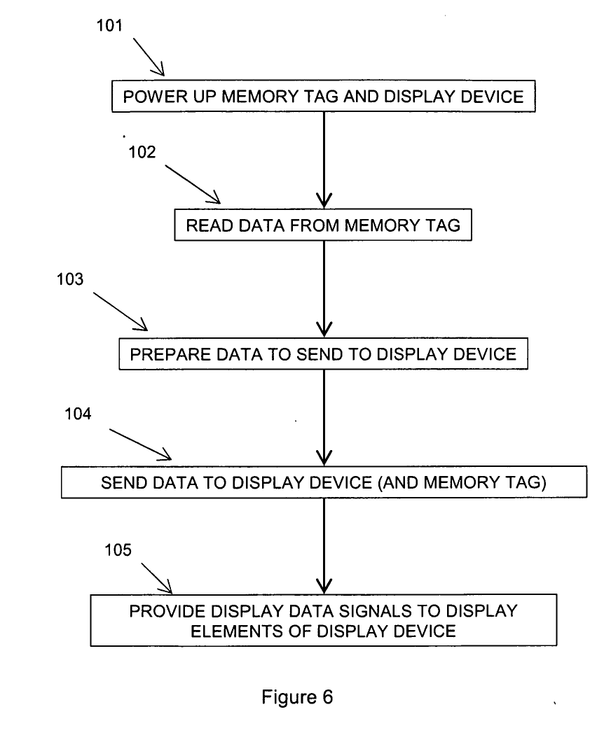

In the arrangement shown in FIG. 5, the memory tag 13 and the display device 10 are separate components that are collocated but which do not directly interact, communicating only through the reader device 11. A method for providing images from data in the memory tag is set out in FIG. 6. It should be noted that an alternative arrangement—as described in the discussion of FIG. 2—is for memory tag and display device functionality to be combined in a single device. However, where high speed and low power operation is necessary, it may be advantageous to provide two relatively simple devices interacting through a reader device (which itself may have far less limiting power and speed constraints) rather than one relatively complex device.

As shown in FIG. 6, the first step 101 is to power up the memory tag and the display device by bringer the reader device into sufficiently close proximity to both. Once the memory tag is powered up, it will provide data to the reader device in the second step 102 by modulating the impedance of the memory tag in the manner described with respect to FIG. 3. This data consists of, or contains, or possibly simply references, an image to be displayed on the display device. The reader device then, in the third step 103, prepares data to send to the display device. If the memory tag simply holds data in a form usable directly by the display functionality of the display device, this step may not be necessary at all. However, if the memory tag only contains a reference to image data, or data in a form not itself adapted for display by a display device (for example, a file in a word processing format, or even in a display format such as TIFF), the necessary processing step is most effectively carried out at the reading device, which can readily be provided with a general purpose processor and the capability to run all necessary applications. In the fourth step 104, data is provided to the display device. For a combined memory tag and display device with a read-only memory tag, this may be achieved straightforwardly—all data sent out by the reader device may be simply display data. However, embodiments which combine a display device with a memory tag which may be written to as well as read from are perfectly possible. In this case, relevant logic of both the memory tag and the display device need to be able to discriminate data which is relevant to their device from other data. This may be achieved by using packetised data with headers. The relevant logic does not read data unless it detects a particular header value which indicates that that packet is relevant to that particular device. Where the particular header is detected, that packet is read. Where that particular header is not detected, the relevant logic simply waits for the next packet and performs the same assessment. In the fifth step 105, the display driver of the display device generates display data signals from the data sent to it by the reader device: for a conventional monostable device, these display data signals are fed with refresh signals to the display elements for as long as the display device is powered; for a bistable or multistable device display data signals are provided to the display elements to replace the existing displayed image with a new image.

In other embodiments of the invention, another functional device rather than (or even as well as) as a display can be collocated with a memory tag to provide a new form of composite device. Such a functional device may be another output device as an alternative to (or in addition to) a display, such as a loudspeaker. Again, a low power CMOS component could effectively be used, and similar approaches could be employed for providing signals to a loudspeaker as are described above for providing signals to a display.

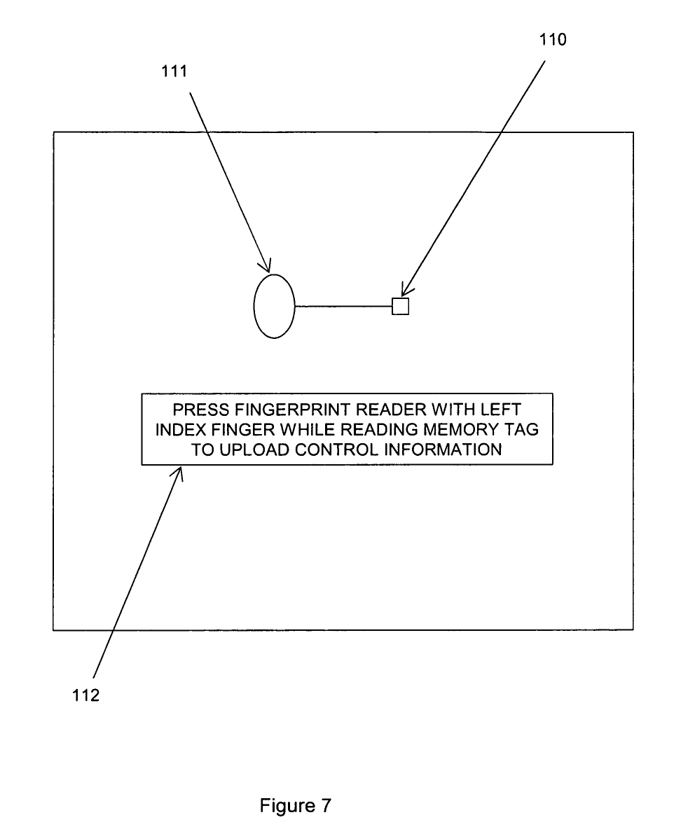

The other functional device need not be an output device—it may instead be an input device. An example is shown in FIG. 7. A circuit device 110 comprises a memory tag overlaid with the circuitry of a fingerprint reader. The fingerprint reader circuitry is connected by wire to the reader pad 111 of the fingerprint reader—this may be a low power CMOS fingerprint reader (examples of CMOS fingerprint readers are widely available). A legend 112 indicates that protected information in the memory tag will be made available on use of the fingerprint reader while powering the memory tag.

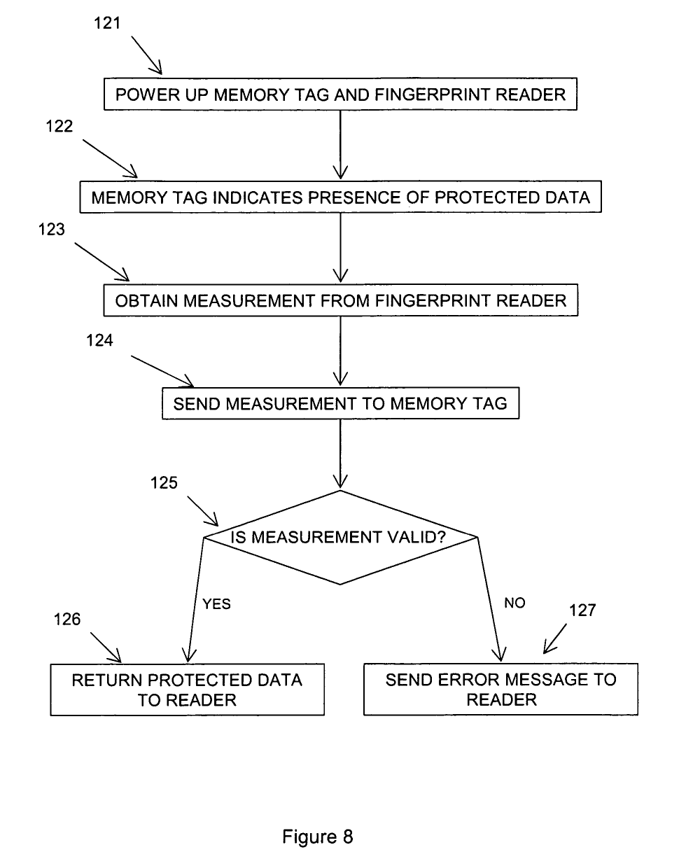

FIG. 8 indicates a method for obtaining protected data from the memory tag. The memory tag and the fingerprint reader are both powered up (121) by moving a reader device into proximity with the antennae of the devices. The reader device reads data from the memory tag (122) and discovers that the memory tag holds protected data (unprotected data may be simply read at this point—this may provide a visual indication to the user that the fingerprint reader is needed, and may provide elements of a user interface for the fingerprint reader). The reader device then obtains (123) a fingerprint measurement from the fingerprint reader (which may, for example, simply obtain a measurement as soon as it is powered up, or on response to a signal from the reader device). This measurement is sent (124) to the memory tag, and the logic of the memory tag determines (125) whether the measurement is a satisfactory match to information relating to allowed fingerprint users that it holds. Alternatives are possible—for example, it may be that the fingerprint reader allows access to all users who provide a fingerprint, but then stores that data in the memory tag to provide an access log. If the measurement is satisfactory (126), the protected data is returned to the reader device. If it is not satisfactory (127), an error message is returned instead.

As for output devices, a variety of different input devices could be used. A touchpad could be employed to provide a confirmation of physical presence at the spot, or even to provide digitised input. A similar approach for providing interaction between the input device and the memory tag could be employed as for the biometric reader and the memory tag described above.

Although embodiments of this invention have been described with respect to a specific memory tag technology, the skilled person will appreciate that other memory tag technologies may be used both for the memory tag itself and in modification for powering and providing data to a display or other functional device.

1. An inductively powered device comprising a memory tag and an additional functional device for powering by and communication with a reader device emitting radio frequency signals, adapted such that when the memory tag is powered by a reader device, the additional functional device is also powered by the reader device and carries out its function.

2. An inductively powered device as claimed in claim 1, wherein the additional functional device is an output device.

3. An inductively powered device as claimed in claim 2, wherein the additional functional device is a display, and the display carries out the function of displaying data transmitted to it by the reader device.

4. An inductively powered device as claimed in claim 3, wherein the data transmitted to the display is derived from data stored on the memory tag.

5. An inductively powered device as claimed in claim 3, wherein an image displayed by the display is provided only while the display is powered by the reader device.

6. An inductively powered device as claimed in claim 3, wherein the display is a bistable or multistable display and the image displayed by the display is provided only while the display is powered by the reader device.

7. An inductively powered device as claimed in claim 1, wherein the additional functional device is an input device.

8. An inductively powered device as claimed in claim 1, wherein the additional functional device is a biometric reader which takes a measurement while the biometric reader is powered by the reader device.

9. An inductively powered device as claimed in claim 8, wherein at least some data in the memory tag is only provided to the reader if the reader provides the measurement from the biometric reader and the measurement meets predefined criteria.

10. An inductively powered device as claimed in claim 8, wherein the biometric reader is a fingerprint reader.

11. A display device powered by radio frequency communication, the display device comprising:
an antenna and an induction circuit for obtaining power from radio frequency transmissions provided by a powering device;
display driver circuitry for providing a display data signal to a display; and
a display for displaying an image according to the display data signal.

12. A display device as claimed in claim 11, wherein the display device comprises a memory, and wherein the display data signal is derived from data stored in the memory.

13. A display device as claimed in claim 12, wherein the powering device provides data as well as power in the radio frequency transmissions, and this data is written to the memory.

14. A display device as claimed in claim 11, wherein the image is displayed only while the display device is powered by the powering device.

15. A display device as claimed in claim 11, wherein the display is a bistable or a multistable display, wherein the image may be changed only when the display device is powered by the powering device but is still displayed even when the display device is not powered by the powering device.

16. A bistable or multistable display device comprising an antenna, an induction circuit for obtaining power and data from radio frequency signals, a display driver for producing display data signals from the data, and a bistable or multistable display for displaying an image and for modifying the image in response to the display data signals, wherein the image is displayed whether or not the bistable or multistable display device is powered but is modified only when the bistable or multistable display device is powered.

17. A bistable or multistable display device as claimed in claim 16 and further comprising a memory, wherein the data is written into the memory from the induction circuit and provided to the display driver from the memory, whereby the image displayed by the bistable or multistable display corresponds to the data held in the memory.

18. A method of displaying data stored in a memory of an inductively powered memory tag, comprising:
a reader device providing radio frequency signals to the inductively powered tag with to power the inductively powered tag and to read data from the memory;
the reader device powering an inductively powered display device and providing data for display derived from the data read from the memory to the inductively powered display device, whereby an image is displayed on the inductively powered display derived from the data in the memory.

19. A method as claimed in claim 18, wherein the image is displayed only while the reader device is powering the inductively powered display device.

20. A method as claimed in claim 18, wherein the inductively powered display device is a bistable or multistable inductively powered display device and the image is displayed whether or not the reader device is powering the inductively powered display device but is changed only when reader device is powering the inductively powered display device.

21. A method of providing authenticated access to data stored in a memory of an inductively powered memory tag, comprising:
a reader device powering an inductively powered biometric reader which takes a measurement while the biometric reader is powered by the reader device and provides the measurement to the reader device;
the reader device providing radio frequency signals to the inductively powered tag with to power the inductively powered tag, to provide data derived from the measurement to the inductively powered tag and to read certain of the data from the memory if the data derived from the measurement matches predefined criteria.
